(19) United States
(12) Patent Application Publication
(10) Pub. No.: US 2021/0114107 A1
(43) Pub. Date: Apr. 22, 2021

(54) SHAPING METHOD AND SHAPING DEVICE

(71) Applicant: CANON KABUSHIKI KAISHA, Tokyo (JP)

(72) Inventors: Hirokazu Usami, Kanagawa (JP); Akira Sugiyama, Kanagawa (JP)

(21) Appl. No.: 17/134,921

(22) Filed: Dec. 28, 2020

Related U.S. Application Data
(63) Continuation of application No. PCT/JP2019/025771, filed on Jun. 28, 2019.

(30) Foreign Application Priority Data
Jul. 4, 2018 (JP) 2018-127410

(51) Int. Cl. B22F 10/16; B22F 1/00; B29C 64/153; B33Y 10/00; B33Y 30/00; B33Y 70/10

(52) U.S. Cl. CPC B22F 10/16; B22F 1/0011; B29C 64/153; B22F 2304/10; B33Y 30/00; B33Y 70/10; B33Y 10/00

(57) ABSTRACT

According to the present invention, it is provided a shaping method including a formation step of forming a powder layer using a first powder, an arrangement step of arranging a second powder having an average particle diameter smaller than that of the first powder in a partial region of the powder layer, and a first heating step of heating the powder layer on which the second powder has been arranged at a temperature at which particles contained in the second powder are sintered or melted. When a compressive strength of the powder layer in the partial region after the first heating step is denoted by P1 and a compressive strength of the first powder outside the partial region is denoted by P2, a relationship of P1≥0.5 MPa>P2 is established.

### CROSS-REFERENCE TO RELATED APPLICATIONS

This application is a Continuation of International Patent Application No. PCT/JP2019/025771, filed Jun. 28, 2019, which claims the benefit of Japanese Patent Applications No. 2018-127410, filed Jul. 4, 2018, which is hereby incorporated by reference herein in their entirety.

### BACKGROUND OF THE INVENTION

### Field of the Invention

The present invention relates to a method for shaping a three-dimensional article by using a particulate material.

### Description of the Related Art

A layered shaping method in which a shaping material is layered according to slice data of a three-dimensional model of an object to be shaped has been drawing attention as a method for shaping three-dimensional articles. In the past, shaping using resin materials was the mainstream, but in recent years, the number of devices that perform shaping using shaping materials other than resin, such as metals and ceramics, has been increasing.

PTL 1 discloses a method for obtaining a shaped article by repeating a step of forming a thin layer of a powder material on a substrate, then locally heating the powder material at a high temperature with a laser, and sintering the powder material. In the method of PTL 1, when a structural body is formed on a region where a powder material is not sintered (hereinafter referred to as a “non-shaping portion”), such as an overhang structure or a structure with a moving portion, the powder material present on top of the non-shaping portion needs to be sintered. Since warpage may occur due to local heat shrinkage at that time, a support body (also referred to as a support structure) that suppresses warpage needs to be added to perform shaping of structural bodies of certain shapes. Since the support body is inherently an unnecessary structure, it may be necessary to remove the support body after shaping depending on the shape of the three-dimensional object model. Therefore, it is difficult to shape a three-dimensional model having a shape or structure that makes it difficult to remove the support body. In particular, since it is necessary to use a metal processing machine when removing the support body from a metal shaped article, it is not possible to shape a fine structure from which a support body is difficult to remove physically by the metal processing machine. In addition, since ceramics are easily damaged by a load, it is difficult to selectively remove a support body from a ceramic shaped article.

Further, a method is known in which a metal or ceramic shaped article is obtained by producing the shape of a shaped article by using a mixed material of particles such as metal or ceramic and a resin binder, and then removing the resin (binder removal) and sintering. PTL 2 discloses a method for producing a composite shaped article of a resin and metal particles by repeating a step of applying a liquid binder to a metal particle-containing layer to immobilize the particles, and then removing a region where the particles have not been immobilized. The obtained composite shaped article is heat treated to remove the binder and sintered to obtain a metal shaped article.

In the method of PTL 2, when a shape having an overhang structure or a structure having a moving part is produced, shaping is performed by using a powder to which a binder is not applied (powder that is not immobilized) as a substitute for a support body. However, since the powder serving as the support body needs to be removed before binder removal and sintering, the shape cannot be maintained after the binder removal, and deformation or damage can occur. In addition, where shaped forms with different thicknesses are mixed in the shaped article, the amount of impurities in the shaped article, which result, for example, from insufficient binder removal in thick parts, increases, and where the binder is sufficiently removed from the thick parts, thin portions can be deformed and damaged. Therefore, in the shaping method of PTL 2, there are restrictions on the shapes and sizes that can be shaped. Meanwhile, where heat treatment is performed without removing the powder serving as a support body to maintain the shape, the metal particles in the non-shaping portion may be bonded with the metal particles in the shaped part, and the desired shape may not be obtained.

In addition, the shape of the composite shaped article of resin and metal is maintained by the resin component, but where the amount of the resin component is large, it may cause deformation or damage during binder removal, and voids in the formed shaped article. Meanwhile, where the amount of the resin component is small, the strength of the composite shaped article of the resin and metal is weakened, so that the shaped article may be damaged when the particles in the non-shaping portion are removed.

As mentioned above, there is a limit to the shapes that can be shaped by the conventional shaping method. In particular, it is difficult to say that a desired physical property can be obtained or a desired form can be shaped by a method using a shaping material such as metal or ceramics.

The present invention has been made in view of the above circumstances, and an object of the present invention is to provide a shaping technique that can suppress deformation and damage of a shaped article during shaping and has a higher degree of freedom in shape selection.

### CITATION LIST

### Patent Literature

PTL 1 Japanese Patent Application Publication No. 2015-38237

PTL 2 Japanese Patent Application Publication No. 2015-205485

### SUMMARY OF THE INVENTION

According to the first aspect, it is provided a shaping method including a formation step of forming a powder layer using a first powder, an arrangement step of arranging a second powder having an average particle diameter smaller than that of the first powder in a partial region of the powder layer, and a first heating step of heating the powder layer on which the second powder has been arranged at a temperature at which particles contained in the second powder are sintered or melted, wherein where a compressive strength of the powder layer in the partial region after the first heating step is denoted by P1 and a compressive strength of the first powder outside the partial region is denoted by P2, a relationship of

P1≥0.5 MPa>P2

is established.

According to the second aspect, it is provided a shaping device including a formation means for forming a powder layer using a first powder, an arrangement means for arranging a second powder having an average particle diameter smaller than that of the first powder in a partial region of the powder layer, and a heating means for heating the powder layer on which the second powder has been arranged at a temperature at which particles contained in the second powder are sintered or melted, wherein the heating means heats the powder layer such that where a compressive strength of the powder layer in the partial region after the first heating step is denoted by P1 and a compressive strength of the first powder outside the partial region is denoted by P2, a relationship of

P1≥0.5 MPa>P2

is established.

Further features of the present invention will become apparent from the following description of exemplary embodiments with reference to the attached drawings.

### BRIEF DESCRIPTION OF THE DRAWINGS

FIGS. 1A to 1H schematically show a shaping method of an embodiment;

FIGS. 2A to 2G schematically show a shaping method of an embodiment;

FIG. 3 schematically shows the structure of a powder layer in the shaping method of the embodiment;

FIGS. 4A and 4B schematically show a shaping device according to an example;

FIG. 5 represents the evaluation results obtained when a compression strength test of an example was performed;

FIG. 6 schematically shows a measuring device used for the compression strength test of the example;

FIGS. 7A to 7C each represent an example of the test results of the compression strength test of the example;

FIGS. 8A and 8B each represent the relationship between sintering temperature, sintering time, and compressive strength; and

FIG. 9 represents the thresholds of temperature and time at which a shaped article or non-shaping portion cannot be easily crushed.

### DESCRIPTION OF THE EMBODIMENTS

The present invention relates to a shaping method for producing a three-dimensional shaped article using a particulate material. The method of the present invention can be preferably used for a shaping process in a shaping device called an additive manufacturing (AM) system, a three-dimensional printer, a rapid prototyping system, or the like.

Hereinafter, the present invention will be described in detail with reference to preferred embodiments and examples of the present invention. In the drawings, the same reference numerals are given to the parts indicating the same member or the corresponding member. In particular, it is possible to adopt a technique well known in the pertinent technical field or a publicly known technique in a configuration or process not shown or described. In addition, duplicate explanations may be omitted.

(Shaping Method)

The shaping method according to an embodiment of the present invention generally has the following (step 1) to (step 4).

(Step 1) A step of forming a powder layer using first powder.
(Step 2) A step of applying second powder to a shaping portion of the powder layer
(Step 3) A step of sintering or melting the second powder and fixing the first particles in the shaping portion.
(Step 4) A step of removing the first particles outside the shaping portion.

By performing the above (step 1) to (step 4), a sheet-shaped (or plate-shaped) shaped article having a thickness equivalent to one powder layer can be formed. Further, by repeating the above (step 1) and (step 2) and layering a large number of powder layers, a three-dimensional shaped article can be formed.

(Explanation of Each Step)

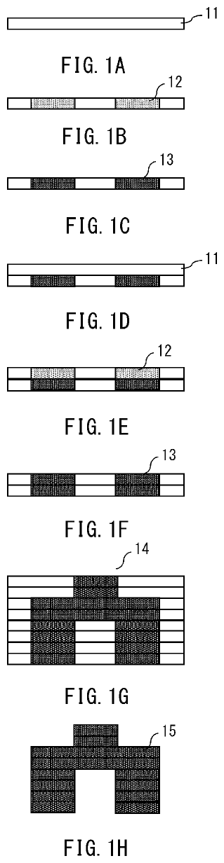

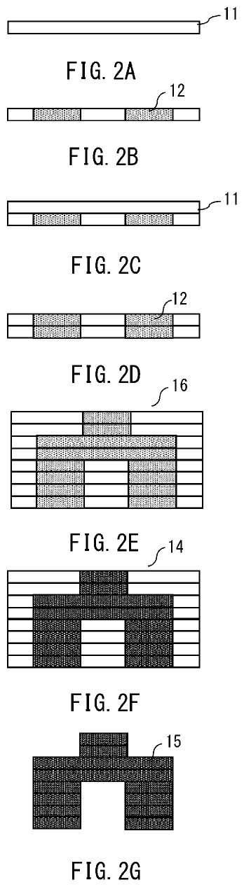

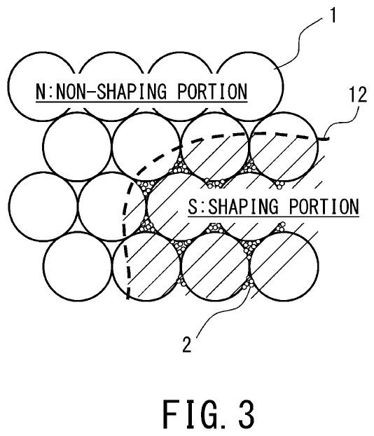

Hereinafter, each step of the shaping method will be described with reference to FIGS. 1A to 1H, FIGS. 2A to 2G, and FIG. 3. FIGS. 1A to 1H and FIGS. 2A to 2G schematically show the flow of the shaping method of the present embodiment. FIGS. 1A to 1H represent an example of a sequence in which (step 1) to (step 3) are repeated a plurality of times and then (step 4) is executed, and FIGS. 2A to 2G represent an example of a sequence in which (step 1) and (step 2) are alternately performed a plurality of times and then (step 3) and (step 4) are executed. FIG. 3 is an enlarged view schematically showing the structure of the powder layer.

It is assumed that slice data for forming each layer are generated from the three-dimensional shape data of the object to be shaped by a shaping device or an external device (for example, a personal computer) before starting the shaping. Data created by a three-dimensional CAD, a three-dimensional modeler, a three-dimensional scanner, or the like can be preferably used as the three-dimensional shape data, and for example, an STL file or the like can be preferably used. The slice data are obtained by slicing a three-dimensional shape of an object to be shaped at a predetermined interval (thickness), and include information such as a cross-sectional shape, a layer thickness, a material arrangement, and the like. Since the thickness of layers affects the shaping accuracy, it is preferable to determine the thickness of layers according to the required shaping accuracy and the diameter of particles used for shaping.

(Step 1) Step of Forming a Powder Layer Using the First Powder

In this step, a powder layer 11 is formed using the first powder including first particles 1 on the basis of the slice data of the object to be shaped (FIGS. 1A and 2A). In the present description, an aggregate of a plurality of particles is referred to as a “powder”, a powder layered to a predetermined thickness is referred to as a “powder layer”, and a configuration obtained by layering a plurality of powder layers is referred to as a “layered body”. At the stage of the present step, the individual particles constituting the powder layer 11 are not fixed, but the form of the powder layer 11 is maintained by the frictional force acting between the particles.

For example, metal particles, ceramic particles, and the like can be used as the first particles 1 constituting the first powder forming the powder layer 11. Specifically, examples of the metal that can be used as the first particles 1 include copper, tin, lead, gold, silver, platinum, palladium, iridium, titanium, tantalum, iron, and the like. Further, a metal alloy such as a stainless alloy, a titanium alloy, a cobalt alloy, an aluminum alloy, a magnesium alloy, an iron alloy, a nickel alloy, a chromium alloy, a silicon alloy, a zirconium alloy, and the like may be used as the first particles 1. Further, a material, such as carbon steel, that is obtained by adding a non-metal element such as carbon to a metal may be used as the first particles 1.

Further, oxide ceramics or non-oxide ceramics may be used as the first particles 1. Examples of oxide ceramics include metal oxides such as silica, alumina, zirconia, titania, magnesia, cerium oxide, zinc oxide, tin oxide, uranium oxide, barium titanate, barium hexaferrite, mullite and the like. Examples of non-oxide ceramics include silicon nitride, titanium nitride, aluminum nitride, silicon carbide, titanium carbide, tungsten carbide, boron carbide, titanium borate, zirconium borate, lanthanum borate, molybdenum silicide, iron silicide, barium silicide, and the like. The first particles 1 may be a plurality of types of metal composite particles or a plurality of types of ceramic composite particles.

The average particle diameter of the first powder is preferably set to a size that does not cause aggregation to ensure satisfactory formation of the powder layer 11. Specifically, the volume-based average particle diameter of the first particles 1 may be selected from the range of at least 1 μm and not more than 500 μm, and preferably selected from the range of at least 1 μm and not more than 100 μm. Where the average particle diameter is at least 1 μm, aggregation of particles during powder layer formation is suppressed and layer formation with few defects is facilitated, and where the average particle diameter is not more than 100 μm, the size of voids contained in the powder layer is reduced, and the strength is easily developed in the sintering step. Where the average particle diameter of the first powder is larger than 500 μm, the surface of the shaped article becomes rough, and there is a concern that a highly accurate shaped article cannot be shaped.

The average particle diameter was measured by a dry method using a laser diffraction-scattering type particle size distribution measuring device LA-950 (manufactured by HORIBA). Sampling was performed with a transmittance in the range of 95% to 99%, and the number of data acquisitions was 10,000. From the obtained measurement results, the volume-based average particle diameter can be calculated.

The powder layer 11 can be formed, for example, by using a container having an upper opening, an elevating support set inside the container, and a material supply device provided with a wiper, as disclosed in Japanese Patent Application Publication No. H08-281807. Specifically, one powder layer 11 can be formed by adjusting the upper surface of the support to a position lower than the upper edge of the container by one layer thickness, supplying the material onto the flat plate by the material supply device, and then flattening the material with the wiper. Alternatively, the powder layer 11 of desired thickness may be formed by supplying the first powder onto a flat surface (the surface of the stage or the shaped article being produced) and leveling the surface of the powder with a layer thickness controlling means (for example, a blade). Further, the powder layer 11 may be pressurized with a pressurizing means (for example, a pressurizing roller, a pressurizing plate, and the like). As the number of contact points between particles increases due to pressurization, defects in the shaped article tend to be less likely to be formed. Further, since the first particles 1 in the powder layer are densely present, the first particles 1 are prevented from moving (the shape of the powder layer 11 collapses) during subsequent treatment in (step 2) and (step 3), and it is possible to produce a shaped article with high shape accuracy.

(Step 2) Step of Arranging the Second Powder in the Shaping Portion of the Powder Layer

In this step, the second powder including second particles 2 and having an average particle diameter of at least 1 nm and not more than 500 nm is applied to a shaping portion S of the powder layer 11 by an application device on the basis of the slice data of the object to be shaped (FIGS. 1B, 2B). The application may be performed by a method for coating of applying the second powder by an air flow or a method of applying the liquid 12 in which the second powder is dispersed, but as described hereinbelow, the merit of using the liquid is that the second particles 2 can be accumulated in the contact portion between the first particles 1. Here, the “shaping portion S” refers to a region corresponding to the cross section of the object to be shaped (that is, a portion of the powder layer 11 where the powder should be solidified and taken out as a shaped article, a partial region of the powder layer). The region other than the shaping portion S (that is, a portion where the powder should be finally removed, a region outside the partial region the powder layer) is referred to as “non-shaping portion N”.

The second powder is a powder that at least can be sintered and melted at a lower temperature and/or in a shorter time than the first powder. This can be rephrased as follows. When the mixed powder of the first powder and the second powder is heated, the heating conditions (temperature, time, and the like) can be set such that the second particles 2 constituting the second powder are sintered or melted, while at least a part of the first particles 1 constituting the first powder are not sintered (naturally, not melted either). Further, the second particles 2 can be selected such that when the mixed powder of the first powder and the second powder is heated, the heating conditions can be set such that the first particles 1 can be easily crushed, whereas the second particles 2 are sintered and cannot be easily crushed.

Here, “sintering” refers to a treatment in which a powder is heated at a temperature below the melting point while the particles are in contact with each other to fix (bond) the particles to each other. In addition, “not sintered” is inclusive of a state in which the particles are not fixed to each other and a state in which the particles are fixed with a weak force and the boundary between the particles fixed with a weak force can be confirmed with an electron microscope.

As will be described in detail hereinbelow, the shaping method of the present embodiment has the following features. That is, by heating at a temperature at which the particles contained in the second powder are sintered or melted, the first particles 1 in the shaping portion S are fixed by the second particles 2, and then the first powder in the non-shaping portion N is removed.

The effect of using the second powder including the second particles 2 having an average particle diameter of at least 1 nm and not more than 500 nm is that the sintering or melting start temperature of the second powder is sufficiently reduced as compared to the sintering start temperature of the first powder. This is because the smaller the particle diameter, the higher the free energy when the particles are in contact with each other (particle size effect).

The average particle diameter of the second particles 2 contained in the second powder is more preferably at least 1 nm and not more than 200 nm. Hereinafter, the second particles 2 may be referred to as a nanoparticle 2.

It is preferable that the average particle diameter of the second particles 2 be not more than 200 nm because not only the sintering temperature is lowered, but also the dispersivity of the nanoparticles 2 in a liquid 12 (hereinafter, may be referred to as a nanoparticle dispersion liquid) is improved and the uniformity when the liquid 12 is applied is improved.

The average particle diameter of the nanoparticles 2 is smaller than the average particle diameter of the first particles 1. As a result, the nanoparticles 2 are filled in the gaps between the first particles 1, and the nanoparticles 2 can easily fix the first particles 1 to each other.

The average particle diameter of the nanoparticles 2 may be set to such a size that the nanoparticles 2 can easily enter the gaps between the first particles 1 when the liquid is applied.

Metal particles, ceramic particles, and the like can be used as the nanoparticles 2. Examples of the metal that can be used as the nanoparticles 2 include copper, tin, lead, gold, silver, platinum, palladium, iridium, titanium, tantalum, iron, and the like. Further, a metal alloy such as a stainless alloy, a titanium alloy, a cobalt alloy, an aluminum alloy, a magnesium alloy, an iron alloy, a nickel alloy, a chromium alloy, a silicon alloy, a zirconium alloy, and the like may be used as the nanoparticles 2.

Further, a material, such as carbon steel, that is obtained by adding a non-metal element such as carbon to a metal may be used as the nanoparticles 2.

Further, oxide ceramics or non-oxide ceramics may be used as the nanoparticles 2. Examples of oxide ceramics include metal oxides such as silica, alumina, zirconia, titania, magnesia, cerium oxide, zinc oxide, tin oxide, uranium oxide, barium titanate, barium hexaferrite, mullite and the like. Examples of non-oxide ceramics include silicon nitride, titanium nitride, aluminum nitride, silicon carbide, titanium carbide, tungsten carbide, boron carbide, titanium borate, zirconium borate, lanthanum borate, molybdenum silicide, iron silicide, barium silicide, and the like. The nanoparticles 2 may be a plurality of types of metal composite particles or a plurality of types of ceramic composite particles.

It is preferable that the nanoparticles 2 include at least one kind of the same component as the first particles 1. Where the same component is included, the surface of the nanoparticles 2 and the surface of the first particles 1 are easily bonded to each other when the nanoparticles 2 are sintered, and the first particles 1 can be firmly fixed. Furthermore, it is more preferable that the nanoparticles 2 be composed mainly of the components contained in the first particles 1. The final shaped article is a mixture of the first particles 1 and the nanoparticles 2, and where the nanoparticles 2 are composed of the same components (materials) as the first particles 1, the amount of impurities in the shaped article is reduced, and the material of the shaped article is homogenized, so that the strength and quality of the shaped article can be improved. For example, where the first particles 1 are an iron-containing stainless alloy, iron particles, iron oxide particles, or the like can be preferably used as the nanoparticles 2.

A step of drying the liquid 12 may be provided between the step of applying the liquid 12 to the powder layer 11 and the step (step 3) described hereinbelow. Further, the step of drying the liquid 12 is preferably performed layer by layer. The liquid 12, which is gradually concentrated as the drying progresses, gathers at the grain boundaries between the first particles 1 due to the surface tension of the liquid. As the liquid 12 moves, the nanoparticles 2 in the liquid selectively gather at the grain boundaries between the first particles 1 and aggregate. As a result of the drying step, the first particles 1 can be efficiently and firmly fixed when the nanoparticles 2 are sintered, as described hereinbelow, due to the accumulation of the nanoparticles 2 at the grain boundaries of the first particles 1. When drying the liquid, it is advisable to select the optimum drying conditions such as temperature and time according to the concentration and amount of the liquid 12.

Further, a solvent may be added in order to improve the uniformity of the liquid 12. As a specific solvent, an aqueous solvent, an organic solvent, or a mixed solvent of an aqueous solvent and an organic solvent can be used. Pure water or the like can be used as the water solvent. As the organic solvent, alcohols such as methanol and ethanol, ketones such as methyl ethyl ketone, acetone and acetyl acetone, and hydrocarbons such as hexane and cyclohexane are used. Where the solvent is added to the liquid 12, the solvent is evaporated at an appropriate rate during drying, so that uneven dispersion of the nanoparticles 2 is less likely to occur.

An additive can be added, as appropriate, to control the dispersibility of the nanoparticles 2 in the liquid 12. The liquid 12 may include a functional substance such as a pigment, if necessary.

Further, the liquid 12 may include a binder for fixing the particles. A commonly used substance can be used as the binder, but a substance that is decomposed by the heat treatment in the below-described (step 3), that is, a substance that has a decomposition temperature lower than the temperature at which the nanoparticles are sintered or melted is preferable. As a result of such decomposition of the binder by heating, even though the binder fixes the first particles 1 in the shaping portion S and/or the nanoparticles 2 in the shaping portion S until (step 3), the binder can be removed in (step 3), and therefore is unlikely to become an impurity in the shaped article. Specific examples of the binder include resin materials and water-soluble carbohydrates. The binder is preferably dissolved in the liquid.

Further, the application of the binder may be separated from the application step of the liquid 12, and a step of applying the binder to the powder layer 11 may be provided after (step 2) and before (step 3). In this case, the binder can be applied to the shaping portion S and/or the non-shaping portion N. As a result of adding a binder, the first particles 1 can be temporarily fixed, and the formation of the next powder layer tends to be facilitated.

A method of applying a liquid binder, in which a binder is dissolved in a liquid, by using a liquid applying device is preferable as a method for applying the binder. A resin solution in which a resin material is dissolved in a solvent, a solution in which a water-soluble substance is dissolved in water, or the like can be used as the liquid binder.

It is preferable that the liquid 12 in which the nanoparticles are dispersed and the liquid including the binder be separately applied, because each application device can be optimized independently according to the liquid to be applied, and therefore superior durability of the application devices is likely to be obtained.

The binder contributes to the fixation of the first particles 1 and/or the nanoparticles 2 in the shaping portion S during (step 2), and is decomposed and removed by heating in (step 3). Therefore, the binder applied to the shaping portion S keeps the shape of the shaped article during (step 2), and is decomposed by heat in (step 3), and the decomposed product is removed through the gaps between the first particles. As a result, the binder is less likely to remain as an impurity in the shaped article, and the first particles 1 in the non-shaping portion N can be easily removed. It is preferable to determine the type and amount of the binder so that no residue of the binder occurs.

Any device capable of applying a liquid in a desired amount to a desired position may be used as the liquid application device applying the liquid 12 or the liquid binder. An inkjet device can be preferably used because the amount of liquid and the arrangement position can be controlled with high accuracy.

Where the liquid 12 which is the nanoparticle dispersion liquid and the liquid binder are separately applied, a configuration is preferred in which the application of the nanoparticle dispersion liquid 12 and the liquid binder to the shaping portion S is performed at the same time by an inkjet device having a head provided with nozzles for discharging each liquid.

When ejecting with an inkjet device, the viscosity of the liquid 12 needs to have an appropriate value, and is preferably 50 cP or less, and more preferably 20 cP or less. Meanwhile, it is necessary to set the viscosity of the liquid 12 to an appropriate value in order to rapidly diffuse the liquid 12 between the first particles 1 and to agglomerate the liquid 12 between the first particles 1 during drying. However, when the viscosity is 20 cP or less, it tends to be easier to control the discharge of the fluid composition.

In order to increase the volume density of the shaped article and further increase the strength, it is preferable that the volume concentration of the nanoparticles 2 in the liquid 12 be high within the above viscosity range. However, from the viewpoint of facilitating the accumulation of nanoparticles 2 in the vicinity of the contact point between the first particles 1 in the process of drying the liquid 12, it is desirable that the volume concentration of the liquid 12 be low. Based on these conditions, the volume concentration of the liquid 12 is preferably not more than 50 vol %, and more preferably not more than 30 vol %. It is preferable that the solid content concentration be not more than 50 vol % because nanoparticles 2 tend to accumulate between the first particles 1 when the liquid 12 dries which contributes to efficient fixation of the first particles 1.

Further, the liquid 12 may be applied a plurality of times, or may be dried each time the liquid 12 is applied. By applying the liquid a plurality of times, the concentration of the nanoparticles 2 in the powder layer 11 in the shaping portion S can be controlled.

(Step 3) a Step of Sintering or Melting the Second Powder and Fixing the First Particles in the Shaping Portion to Each Other

In this step, the powder layer 11 is heated under the conditions such that the second powder is sintered or melted, so that the first particles 1 in the shaping portion S are fixed to each other through the sintered or melted nanoparticles 2 (FIGS. 1C, 1F, and 2F).

Reference numeral 13 in FIGS. 1C and 1F indicates a region in which particles are fixed to each other. In the shaping process shown in FIGS. 1A to 1H, (step 1) to (step 3), that is, the steps shown in FIGS. 1D to 1F, are repeated, and the powder layers are layered while fixing only the particles in the shaping portion S, thereby forming a layered body 14 including an object to be shaped inside thereof. Further, in the shaping process of FIGS. 2A to 2G, (step 1) and (step 2), that is, the steps shown in FIGS. 2C to 2D, are repeated, the powder layers in a state where nanoparticles 2 were applied to the shaping portion S are layered, and then the entire layered body 16 composed of a plurality of powder layers is heated. In this shaping process, as in FIG. 1G, the layered body 14 including the shaped article thereinside is formed. A step of pressurizing the layered body 16 may be provided before heating the layered body 16. This is because by pressurizing the layered body 16, the number of contacts between the first particles 1 increases, and the interparticle bonding during heating tends to proceed efficiently.

At this time, where the melting point of the nanoparticles 2 is lower than the melting point of the first particles 1, and the heating temperature is set to be equal to or higher than the melting point of the nanoparticles 2 and lower than the melting point of the first particles 1, the first particles 1 can be connected and fixed to each other only in the location where the nanoparticles 2 were applied.

The atmosphere during heating can be arbitrarily determined according to the type of material. For example, in the case of a metal, it is preferable to perform heating in an inert gas such as Ar, N₂, or the like or in an atmosphere containing a small amount of oxygen such as a hydrogen gas atmosphere or a vacuum atmosphere because oxidation of the metal during sintering can be suppressed.

Further, in (step 3), the organic component and the resin can be removed by heat in the situation where the first particles are present in the surroundings, so that the shape of the shaped article can be maintained while reducing the residual carbon component in the shaped article. In particular, even when shaped sections having different thicknesses are mixed in the shaped article, since the organic component and the resin component thereinside can be removed, excellent degree of freedom in the shape of the shaped article is achieved.

(Step 4) Step of Removing the First Particles Outside the Shaping Portion

In this step, the powder outside the shaping portion S is removed from the layered body 14 obtained in (step 3) to obtain a shaped article 15 (FIGS. 1F and 2G). Any method, including a known method, may be used as a method for removing unnecessary powder from the layered body 14. For example, cleaning, air blowing, suction, vibration, a physical removal method using a brush or the like can be mentioned.

Specifically, as will be described hereinbelow, where the appropriate sintering temperature and sintering time are selected, the first particles 1 contained in the powder to be removed in the shaping method of the present embodiment are not fixed, or even if the first particles are fixed, they are fixed weaker than in the shaping portion S, and are therefore very easy to remove. In addition, the removed powder can be recovered and reused as a shaping material.

The shaping method of the present embodiment described above has the following features.
Rather than directly bonding the first particles 1 which are the main shaping material to each other, the nanoparticles 2 are sintered or melted, and the first particles 1 present therearound are indirectly bonded by the bonding action of the nanoparticles 2. Therefore, the shape of the shaped article can be controlled by controlling the application position and range of the nanoparticles 2. Moreover, since the nanoparticles 2 are applied in the state of the nanoparticle dispersion liquid 12, the application position, range, amount, etc. of the nanoparticles 2 can be easily and highly accurately controlled by using an application device such as an inkjet device.
Since the nanoparticles 2 are sintered or melted, the first particles 1 can be firmly bonded to each other. Further, since the nanoparticles 2 have an action of filling the gaps of the first particles 1, the void ratio of the shaped article can be reduced.
In (step 3), the location where the nanoparticles 2 are present is selectively fixed, so that the particles in the non-shaping portion N can be easily removed. Further, since it is not necessary to apply a large force when removing the particles from the non-shaping portion N, there is little risk of breaking or damaging the shaped article.
Since the first particles 1 outside the shaping portion S maintain the form until immediately before (step 4), when there is an overhang structure, the first particles 1 under the overhang structure can be used as a support body.

This makes it possible to suppress deformation and cracking of the shaped article. Moreover, the first particles 1 used as the support body are easy to remove.

Therefore, according to the shaping method of the present embodiment, shaping of a complicated shape or a fine shape, which was difficult to shape by the conventional method, can be performed easily and with high quality by using a metal material.
When the layered body 16 is formed and heated as a whole as shown in FIGS. 2A to 2G, the entire shaped article is uniformly heated. Therefore, local thermal shock is reduced, and strain and cracking during the formation of the shaped article are reduced.
Since shaping can be performed without using a resin, shrinkage and deformation of the shaped article caused by binder removal can be avoided. Further, by using no resin or by using a resin and removing the resin in (step 2), a shaped article having few impurities can be produced.

The above-mentioned (step 1) to (step 4) merely exemplify the basic steps of the shaping method of the present embodiment, and the scope of the present invention is not limited to the above-mentioned contents. The specific processing contents of the above-mentioned steps may be changed, as appropriate, or steps other than the above-mentioned steps may be added.

For example, after (step 4), a step of heating the shaped article 15 at a temperature higher than the heating temperature in (step 3) may be provided. By performing such an additional heat treatment, the density of the shaped article 15 can be increased. In this case, the shaped article 15 may be heated under the sintering conditions (heating temperature, heating time, and the like) of the first particles 1. By sintering the first particles 1 to each other, the characteristics of the shaped article 15 can be improved and the strength can be further increased.

The shaped article 15 obtained by the method of the present embodiment is basically composed of only the shaping materials (first particles 1 and nanoparticles 2), and does not have to include a binder such as a resin binder like the shaped articles obtained by the conventional methods.

Therefore, even if the shaped article 15 is additionally heated (sintered), the composition change of the shaped article 15 occurring in the course of the heat treatment is small. Further, in the conventional method, the shape of the shaped article may change when the resin is removed by heat treatment, but in the case of the shaped article 15 of the present embodiment, such a problem is unlikely to occur.

(Method for Producing Particles)

The first particles 1 and the nanoparticles 2 may be produced by any method including known methods. For example, as a method for producing metal particles, a gas atomizing method and a water atomizing method can be preferably used because substantially spherical particles can be obtained. In addition, as a method for producing ceramic particles, a wet method such as a sol-gel method or a dry method in which a metal oxide liquefied in high-temperature air is cooled and solidified can be preferably used because substantially spherical particles can be obtained.

### Example

Next, a specific example of the manufacturing method according to the above embodiment will be described.

### <First Particles>

A SUS316L gas atomized powder (LPW, LPW-316-AAAV, average particle diameter 30 μm) was used as the first powder in the present example.

### <Second Particles>

Iron nanoparticles (Sigma-Aldrich, average particle diameter 25 nm) were used as the nanoparticles of the second powder.

### <Nanoparticle Dispersion Liquid>

The nanoparticle dispersion liquid 12 was obtained by dispersing 5.0 g of the above-mentioned iron nanoparticles in 45.0 g of ethanol (special grade manufactured by Kishida Chemical Co., Ltd.). The volume concentration of iron nanoparticles in the obtained nanoparticle dispersion liquid was 1.1 vol %. The viscosity of solution A was 1.2 cP.

<Shaped Article Preparation Step>

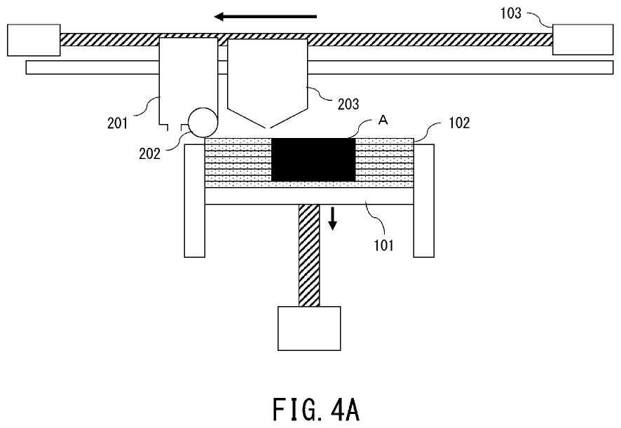

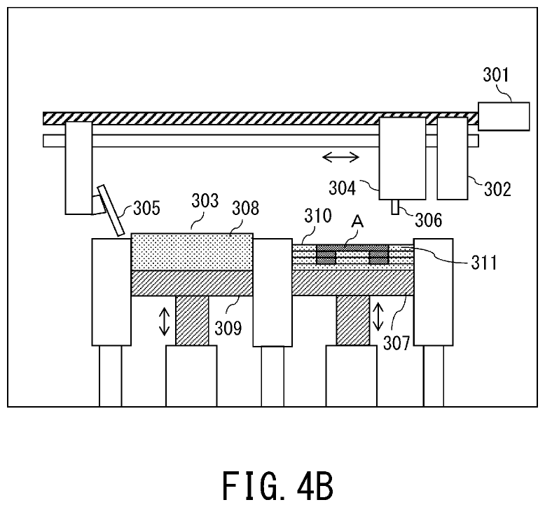

The shaping method according to the present example can be carried out using, for example, a shaping device such as shown in FIG. 4A. In the shaping device of FIG. 4A, a supply device 201 for supplying the first powder, a roller 202 for leveling the layer of the first powder, and an application device 203 for applying nanoparticles are movably arranged on a shaft provided with a transfer motor 103.

The first powder is supplied from the supply device 201 to a shaping stage 101, and then a uniform powder layer 102 is formed by the rollers 202. After that, the nanoparticles 2 are applied to the shaping portion S by the application device 203. After the nanoparticles have been applied, the shaping stage 101 descends by one layer, the powder layer 102 is formed again, and the above steps are thereafter repeated.

In the present example, after forming a uniform layer of 20 mm×10 mm and a thickness of 100 μm by using the first powder, the nanoparticle dispersion liquid 12 was dropped onto the shaping portion S. At this time, one powder layer 102 was completed by repeating four times the operation of dropping once and then drying and dropping in the same place. This was repeated for 20 layers to prepare a shaped article A (ϕ5 mm, thickness 2 mm) as shown in FIG. 4A.

The shaping method according to the present example can also be carried out by using a shaping device as shown in FIG. 4B.

This shaping device includes a powder accommodation unit 303 having a stage 309, a stage 307, a blade 305, a liquid supply unit 304, a liquid application unit 306, a heater 302, and a drive mechanism 301. In the powder accommodation unit 303, a first powder 308 is accommodated on the stage 309. The blade 305 has a function of supplying the powder accommodated in the powder accommodation unit 303 onto the stage 307 and leveling the powder supplied on the stage 307. Any member having such function (for example, a roller-shaped member) can be used instead of the blade 305. The stage 307 is configured to be movable in the vertical direction. The stage 309 is also configured to be movable in the vertical direction. A shaped article A which is produced by layering powder layers 311 supplied and leveled by the blade 305 is arranged on the stage 307. The liquid supply unit 304 accommodates a nanoparticle dispersion liquid 12. The liquid application unit 306 applies the nanoparticle dispersion liquid 12 accommodated in the liquid supply unit 304 to the powder layer 311 on the stage 307. The heater 302 heats the powder layer on the stage 307. Further, the blade 305, the liquid supply unit 304, the liquid application unit 306, and the heater 302 are provided on a movable head.

When shaping is performed, first, the stage 309 is raised in order to supply the first powder in an amount of one layer onto the stage 307 from the powder accommodation unit 303 on the basis of the thickness defined by the slice data. At this time, the stage 307 is lowered by the distance for forming one powder layer 311 also on the basis of the thickness defined by the slice data. After that, the blade 305 moves on the powder accommodation unit 303, so that the first powder located above the upper surface of the powder accommodation unit 303 is supplied onto the stage 307. The surface of the first powder in the amount of one layer on the stage 307 that has been supplied in this way is leveled by the blade 305 to form the powder layer 311 of the first powder. As a result, the powder layer 311 for one slice of the shaped article is formed.

Next, using the liquid application unit 306, the nanoparticle dispersion liquid 12 is applied to the shaping portion S in the powder layer 311 on the basis of the cross-sectional shape of the object to be shaped that is defined in the slice data. As a result, a powder layer in which the nanoparticles 2 are introduced in the gaps between the first particles 1 in the shaping portion S is formed. Then, using the heater 302, the powder layer is heated under the conditions such that the second particles are sintered or melted while the first particles are not sintered, and the sintered or melted second particles fix the first particles together.

A series of processes such as the formation of a powder layer of the first powder, application of the dispersion liquid, and heating of the powder layer are repeated for each layer on the basis of slice data for each layer to form a layered body 310 in which a plurality of powder layers is layered.

After that, the shaped article A having a desired shape is obtained by removing the first powder of the non-shaping portion N from the layered body 310.

<First Sintering Step>

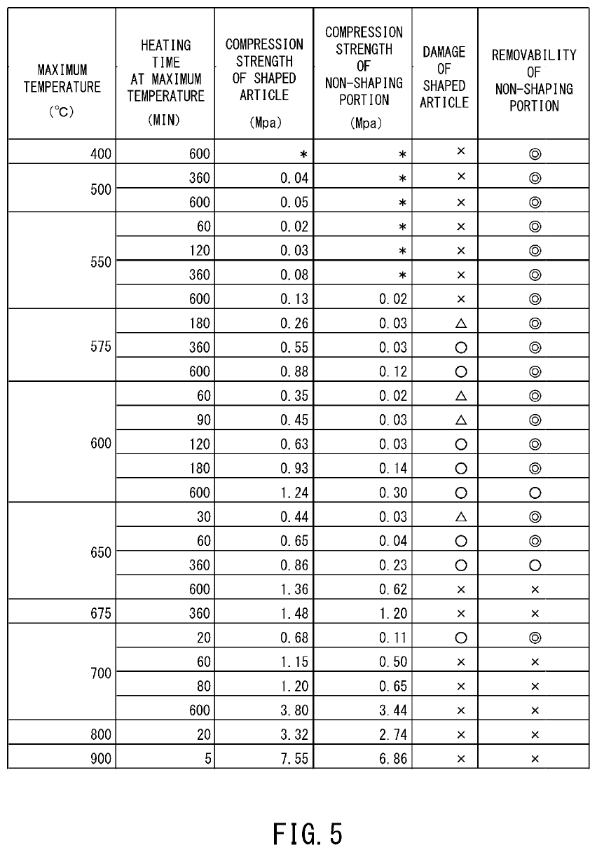

The layered body obtained in the above-described shaped article preparation step and including the non-shaping portion N was heated under the conditions of the heating temperature (sintering temperature) and the heating time (sintering time) shown in FIG. 5. The atmosphere was a nitrogen atmosphere, and the oxygen partial pressure during sintering was adjusted to 10⁻⁴ atm O₂. FIG. 5 shows the conditions of the heating temperature (maximum temperature) and the heating time (heating time at the maximum temperature), as well as the compression strength, the damage state of the shaped article A, and the powder removal state (removability) of the non-shaping portion N described hereinbelow.

### <Take-Out Step>

After the first sintering step, the non-shaping portion N was removed to obtain the shaped article A. The non-shaping portion N was removed by blowing air, and where it could not be removed by air, it was removed using a hobby brush (manufactured by Handy Crown Corporation, horsehair). At this time, as will be described in detail hereinbelow, where the fixed state of the powder of the shaped article A was too weak, the shaped article A could be damaged, and where the fixed state of the powder was too strong, the powder of the non-shaping portion N could not be removed.

### <Second Sintering Step>

The shaped article A obtained in the above-mentioned removal step was sintered in the above-mentioned electric furnace in a nitrogen atmosphere at an oxygen concentration of 10⁻⁸ atm O₂ at 1300° C. for 1 hour to obtain a final shaped article.

By this second sintering step, the first particles 1 can be sintered with each other, so that the density of the shaped article A obtained in the first sintering step can be increased. Here, the shaped article A is heated under the conditions such that the first particles 1 are sintered, but where the heating temperature (T2) in the second sintering step is higher than the heating temperature (T1) in the first sintering step, the density of the shaped article A obtained in the first sintering step can be increased.

<Sintering Temperature and Sintering Time in First Sintering Process>

The sintering conditions of the first sintering step will be described in detail below.

In the first sintering step, since it is necessary to remove the particles of the non-shaping portion N in the subsequent take-out step, only the shaping portion S (nanoparticle application portion) is immobilized, whereas the non-shaping portion N needs to be not immobilized or to be easily removable by crushing. However, where the immobilization of the shaping portion S is too weak, the shaped article A may be damaged during the take-out step. Therefore, the powder of the shaping portion S needs to be fixed with a strength such that the shaping portion cannot be easily crashed.

Therefore, the damage state of the shaped article A, the removal state of the powder of the non-shaping portion N, and the fixing strength of the powder were evaluated with respect to the shaped article A obtained by performing the first sintering step under the sintering conditions (temperature, time) shown in FIG. 5. The fixing strength of the powder was evaluated by the compressive strength, and the compressive strength test was carried out using Tensilon RTC-1250A (manufactured by A&D Co., Ltd.).

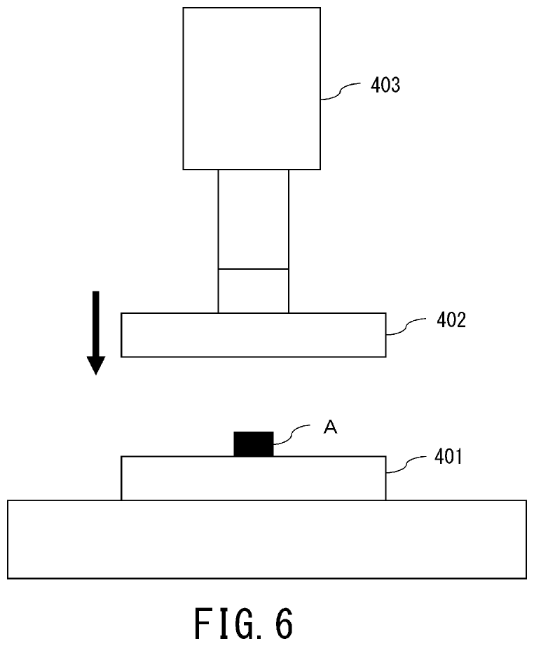

FIG. 6 schematically shows a measuring device used for the compression strength test. As shown in FIG. 6, the shaped article A was installed on a measurement stage 401, a flat plate indenter 402 was introduced from above at a constant speed, and the stress at that time was measured with a load cell 403.

There was a case in which the fixed state of the powder of the shaped article A was weak, and the shaped article was damaged and could not be taken out. In such a case, first, the particles of the portion to which the nanoparticles in the shaped article preparation step were applied were filled in an alumina container having a diameter of 5 mm and a depth of 2 mm, and the first sintering step was performed. Then, on the measurement stage 401, the alumina container was turned upside down, and the particles were taken out, while maintaining the cylindrical shape, to form the shaped article A.

Further, in order to measure the fixing strength of the particles of the non-shaping portion N, a sample in which only the first particles 1 were filled was similarly prepared and measured. In the present example, the moving speed of the flat plate indenter 402 was set to 1 mm/min.

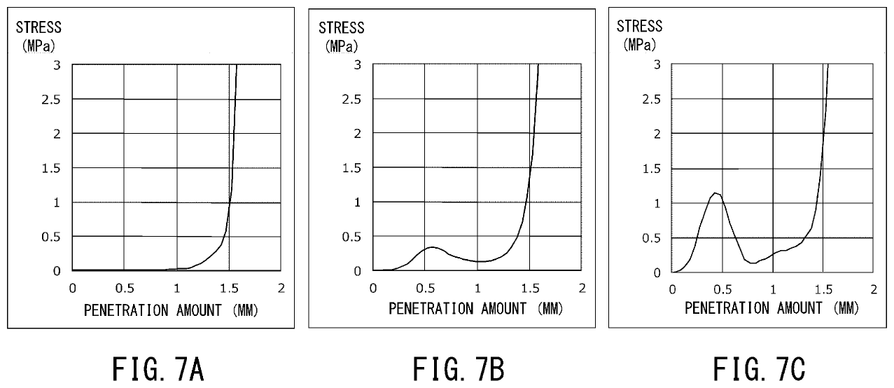

FIGS. 7A to 7C represent examples of the test results of the compression strength test. FIGS. 7A to 7C represent the results obtained when the above-mentioned compression strength test was performed on the shaped article A obtained under the heating conditions of 550° C. for 60 min, 600° C. for 60 min, and 700° C. for 60 min, respectively.

As can be seen from FIGS. 7A to 7C, the transition of stress has a peak as the sintering progresses. In the state shown in FIG. 7A, the particles are not fixed to each other or are very weakly fixed, and the particles are easy to move. Therefore, where the flat plate indenter 402 is introduced, the particles escape to a space to which they can easily escape, and the stress begins to rise when there is no escape place for the particles anymore.

Meanwhile, in the states shown in FIGS. 7B to 7C, the particles are firmly fixed to each other. Therefore, the particles cannot escape against the penetration of the flat plate indenter 402, and as a result, a repulsive force is applied to the flat plate indenter 402. However, as the penetration of the flat plate indenter 402 progresses, the fixed portions between the particles are destroyed, the particles can move, and the repulsive force decreases, so that a stress peak occurs. After that, when there is no escape place for the particles, the stress starts to rise again. In the state shown in FIG. 7C, sintering proceeds more than in the state shown in FIG. 7B, and the particles are more firmly fixed. Therefore, in the state of FIG. 7C, the peak value is larger than that in the state shown in FIG. 7B.

FIG. 5 further shows the evaluation results of the compression strength, the damage state of the shaped article A in the take-out process, and the removal state (removability) of powder of the non-shaping portion N. The * mark in FIG. 5 indicates that the sample collapsed under its own weight and the strength test could not be performed.

Regarding the damage state of the shaped article A, out of 5 times of shaping:

∘: No damage occurred

Δ: Damage sometimes occurred

x: Damaged occurred/not take-out was possible.

Regarding the powder removal state of the non-shaping portion N,

⊚: Could be easily removed by blowing air

∘: Could be easily removed with a hobby brush

x: Removal was difficult/impossible.

As can be seen from FIG. 5, when the compression strength was at least 0.5 MPa, the particles were not easily crushed, and when the compression strength was less than 0.5 MPa, the particles could be easily crushed. In other words, from this, the following can be understood. Thus, where the compressive strength of the shaped article A after the first sintering step (after the heating step and after heating) is denoted by P1 and the compressive strength of the non-shaping portion N is denoted by P2, where the relationship shown in the following formula 1 is satisfied, the particles of the non-shaping portion N can be easily removed and the shaped article A can be taken out while suppressing the damage of the shaped article A.

P1≥0.5 MPa>P2 (Formula 1)

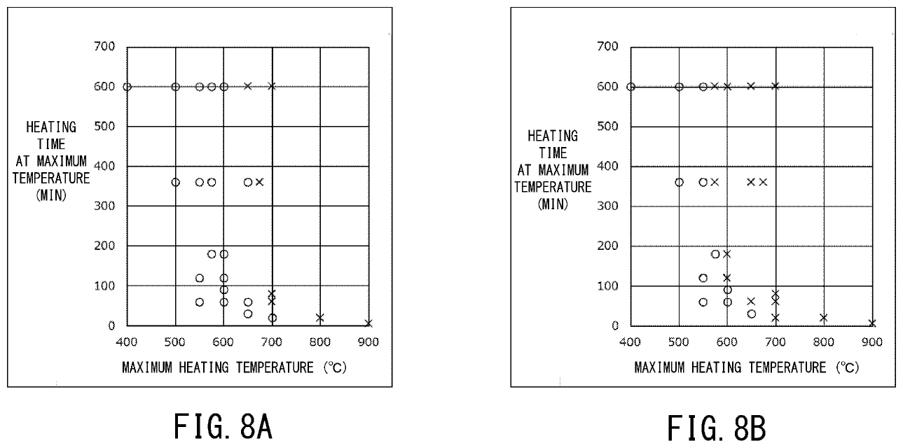

FIGS. 8A and 8B are graphs showing the compression strength when the sintering temperature (maximum heating temperature) is plotted against the abscissa and the sintering time (heating time at the maximum heating temperature) is plotted against the ordinate. FIG. 8A shows data relating to the non-shaping portion N, and FIG. 8B shows data relating to the shaped article A.

In FIGS. 8A to 8B,

∘: Compressive strength is smaller than 0.5 MPa

x: Compression strength is at least 0.5 MPa.

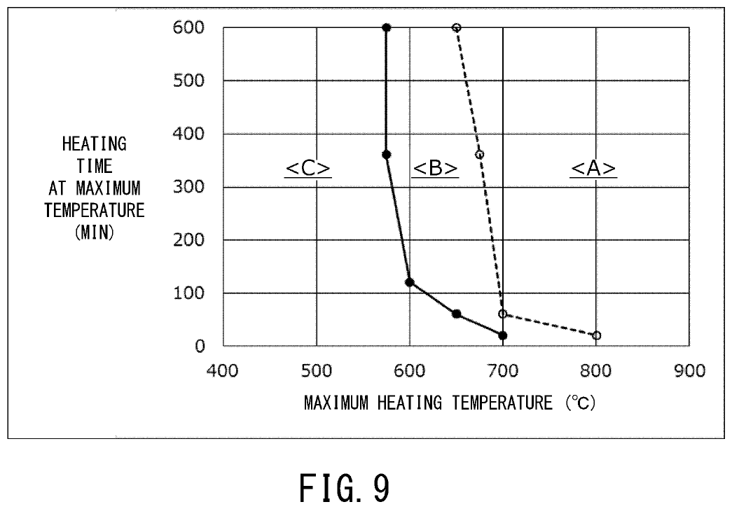

FIG. 9 shows the connected threshold values of the temperature and time at which the non-shaping portion N and the shaped article A cannot be easily crushed and which are based on the results shown in FIGS. 8A and 8B, respectively. In FIG. 9, the solid line represents the threshold values of the shaped article A, and the broken line represents the threshold values of the non-shaping portion N. That is, in the region shown by <A> in FIG. 9, both the shaped article A and the non-shaping portion N are solidified and the shaped article A cannot be taken out. In the region shown by <B> in FIG. 9, the shaped article A is sufficiently solidified, but the non-shaping portion N can be easily crushed, and thus the shaped article A can be easily taken out while being prevented from being damaged. In the region shown by <C> in FIG. 9, the non-shaping portion N can be easily crushed, but the shaped article A is also easily crushed.

Therefore, under the conditions of the present example, where the first sintering step is performed at the sintering temperature and sintering time included in the region shown by <B> in FIG. 9, the particles of the non-shaping portion N can be easily removed and the shaped article A can be taken out while preventing the shaped article A from being damaged.

As described above, in the present embodiment, the sintering step (first sintering step) is performed by setting the conditions of the sintering temperature and the sintering time such that the relationship of P1≥0.5 MPa>P2 (Formula 1) is established. Since the shaped article A obtained by such a sintering step is firmly solidified and the non-shaping portion N can be easily crushed, and the shaped article A can be taken out while suppressing deformation or damage of the shaped article A in the take-out step after the sintering process.

Therefore, according to the present embodiment, it is possible to suppress deformation and damage of the shaped article at the time of shaping, and it is possible to provide a shaping technique with a higher degree of freedom in shape.

According to the present invention, it is possible to provide a shaping technique that can suppress deformation and damage of a shaped article during shaping and has a higher degree of freedom in shape selection.

### Other Embodiments

Although the present invention has been described above in specific embodiments, the present invention is not limited to the above embodiments, and various modifications may be made without departing from the technical idea of the present invention. For example, the types of particles, the atmosphere of the sintering step, and the like are not limited to the conditions shown in the examples. When the type of particles, the sintering atmosphere, and the like are different from those in the examples, the sintering conditions (heating temperature, heating time) that satisfy the relationship of Formula 1 and correspond to the conditions of the examples may be set.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A shaping method comprising:
a formation step of forming a powder layer using a first powder;
an arrangement step of arranging a second powder having an average particle diameter smaller than that of the first powder in a partial region of the powder layer; and
a first heating step of heating the powder layer on which the second powder has been arranged at a temperature at which particles contained in the second powder are sintered or melted, wherein
where a compressive strength of the powder layer in the partial region after the first heating step is denoted by P1 and a compressive strength of the first powder outside the partial region is denoted by P2, a relationship of
P1≥0.5 MPa>P2
is established.

2. The shaping method according to claim 1, wherein
an average particle diameter of the first powder is at least 1 μm and not more than 500 μm.

3. The shaping method according to claim 1, wherein
an average particle diameter of the second powder is at least 1 nm and not more than 200 nm.

4. The shaping method according to claim 1, wherein
particles constituting the second powder have a lower melting point than particles constituting the first powder.

5. The shaping method according to claim 1, further comprising:
a removal step of removing the first powder outside the partial region after the first heating step; and
a second heating step of heating the powder layer in the partial region obtained by the removal step.

6. The shaping method according to claim 5, wherein
where a heating temperature in the first heating step is denoted by T1 and a heating temperature in the second heating step is denoted by T2,
T2>T1.

7. The shaping method according to claim 1, further comprising:
a step of pressurizing the powder layer between the formation step and the arrangement step.

8. A shaping device comprising:
a formation means for forming a powder layer using a first powder;
an arrangement means for arranging a second powder having an average particle diameter smaller than that of the first powder in a partial region of the powder layer; and
a heating means for heating the powder layer on which the second powder has been arranged at a temperature at which particles contained in the second powder are sintered or melted, wherein
the heating means heats the powder layer such that
where a compressive strength of the powder layer in the partial region after the first heating step is denoted by P1 and a compressive strength of the first powder outside the partial region is denoted by P2, a relationship of
P1≥0.5 MPa>P2
is established.
